(19) United States
(12) Patent Application Publication
(10) Pub. No.: US 2023/0418082 A1
(43) Pub. Date: Dec. 28, 2023

(54) VEHICLE DISPLAY DEVICE WITH PARAMETERISABLE VIRTUAL IMAGE

(71) Applicant: PSA AUTOMOBILES SA, Poissy (FR)

(72) Inventors: Aref Antoine TAHHAN, LA CELLE ST CLOUD (FR); Chloe ALLEAU, PARIS (FR)

(21) Appl. No.: 18/254,347

(22) PCT Filed: Nov. 9, 2021
(86) PCT No.: PCT/FR2021/051975

§ 371 Date: May 24, 2023

(30) Foreign Application Priority Data
Dec. 21, 2020 (FR) 2013800

(51) Int. Cl. G02B 27/14; B60K 35/00

(52) U.S. Cl. CPC G02B 27/144; B60K 35/00; B60K 2370/167; B60K 2370/27

(57) ABSTRACT

Vehicle display device with parameterizable virtual image. The invention relates to a vehicle display device (1) including a first display surface (2) and a second display surface (3), which are different, the first display surface (2) being semi-transparent and configured to create a virtual image obtained by reflection of an image produced by a display source (6), the second display surface (3) being visible through the first display surface (2), the display device (1) including a first display mode in which at least one first information item is displayed on the first display surface (2) and at least one second information item is displayed on the second display surface (3), characterized in that it further includes a second display mode in which the at least one first information item and the at least one second information item are displayed on the second display surface (3) and in which the display source (6) is switched off.

### CROSS-REFERENCE TO RELATED APPLICATIONS

This application is the US National Stage under 35 USC § 371 of International Application No. PCT/FR2021/051975, filed Nov. 9, 2021, which claims the priority of French application 2013800 filed on Dec. 21, 2020, the content (text, drawings and claims) of both said applications being incorporated by reference herein

### TECHNICAL FIELD

The devices disclosed herein relate to vehicle display devices and more particularly to instrument clusters.

### BACKGROUND

In the field of motor vehicles, it is customary to display information intended for a user of a motor vehicle, such as the driver. For this purpose, it is increasingly common for modern vehicles to include at least one generally flat and rectangular digital display panel integrated into the dashboard. Thus, display devices are known that make it possible to create virtual images obtained by reflection of images produced by a first digital display panel on a partially reflecting strip disposed in the field of view of the driver and behind which is disposed, in a manner visible for the driver, a second display source, such as a second digital display panel or else a conventional instrument panel. International patent application WO2005018976 describes such a device.

Such display devices offer new possibilities for displaying and showcasing information intended for the driver in order to improve ergonomics and information management by the driver. Indeed, they have two discrete display surfaces, disposed one behind the other, capable of displaying a virtual image that appears to float in front of another image. However, the use of a virtual image is not always desirable.

### SUMMARY

It is an object to propose a solution for adapting the display of an instrument cluster providing a virtual image.

To this end, the device comprises a vehicle display device including a first display surface and a second display surface, which are discrete, the first display surface being semi-transparent and designed to create a virtual image obtained by reflection of an image produced by a display source, the second display surface being visible through the first display surface, said display device including a first display mode wherein at least one first information item is displayed on the first display surface and at least one second information item is displayed on the second display surface, characterized in that it further includes a second display mode wherein the at least one first information item the at least one second information item are displayed on the second display surface and wherein the display source is switched off.

The display device adapts by displaying all of the information on a two-dimensional plane (the second display surface) in the second display mode. Furthermore, the illumination that produces the three-dimensional effect (the display source) is stopped in order to avoid the unwanted effects of reflections.

The disclosed device makes it possible to benefit from the display of all the information without three-dimensional effects in the second display mode when these effects are considered to be undesirable by the user (for example in the event of visual fatigue or nighttime driving).

Advantageously, the display source is a digital screen.

Advantageously, the first display surface is a semi-transparent strip.

Advantageously, the second display surface is a digital screen.

Advantageously, the first information item corresponds to the speed of the vehicle.

Advantageously, the second information item is chosen from: a speed limitation, an indication relating to a cruise control.

Also disclosed is a vehicle including a display device.

### BRIEF DESCRIPTION OF THE FIGURES

Other features and advantages of the devices disclosed herein will become apparent from the description of the non-limiting embodiments below, with reference to the appended figures.

FIG. 1 schematically shows a display device in a first display mode, according to a particular embodiment.

FIG. 2 schematically shows a display device in a second display mode, according to a particular embodiment.

### DETAILED DESCRIPTION

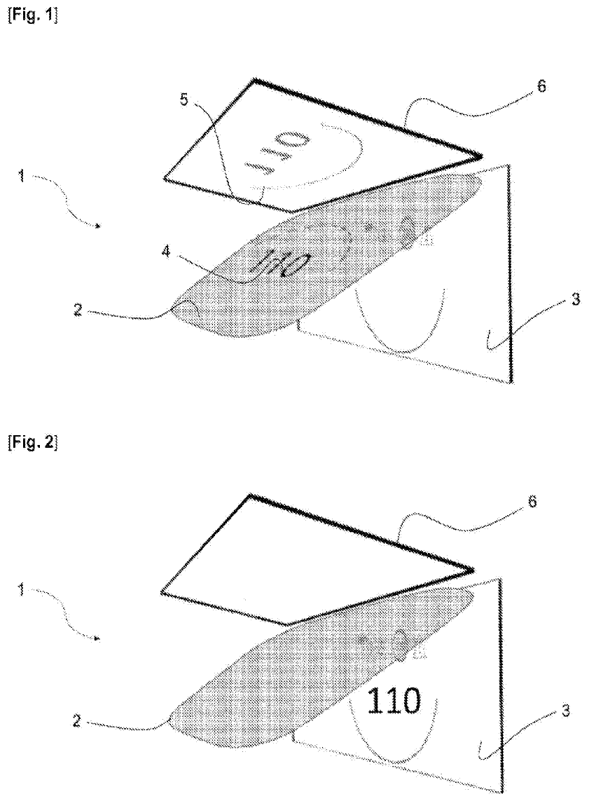

FIG. 1 shows a vehicle display device 1, also referred to as an instrument cluster. This device 1 includes a first display surface 2 and a second display surface 3 which are discrete.

The first display surface 2 is semi-transparent and is designed to create a virtual image obtained by reflection of an image produced by a display source 6.

The second display surface 3 is visible through the first display surface 2.

In the example embodiment of FIG. 1, the display source 6 is a first digital screen. The first display surface 2 is a semi-transparent strip. The second display surface 3 is a second digital screen. The first and second digital screens are substantially perpendicular to each other. The semi-transparent strip forms a substantially forty-five degree angle relative to the first digital screen.

The display device 1 includes a first display mode wherein at least one first information item is displayed on the first display surface 2 and at least one second information item is displayed on the second display surface 3.

In this example, the first information item corresponds to the speed of the vehicle. The speed herein is 110 kilometers per hour. This speed is displayed on the display source 6. The image of the speed is reflected by the semi-transparent strip and appears in the form of a virtual image to the eyes of the driver.

The second information item includes: a speed limitation (herein 130) and an indication relating to a cruise control (herein 135).

The display device 1 further includes a second display mode wherein the at least one first information item and the at least one second information item are displayed on the second display surface 3 and wherein the display source 6 is switched off.

FIG. 2 shows the display device 1 in the second display mode. The display source 6 is switched off and no longer displays the speed. The speed is then displayed on the second display surface 3. The user perceives the same information.

The first information item is disposed on the second display surface 3 so as to appear substantially at the same location as when it is displayed in the first mode, but it appears in the same way as the other information items.

1. A vehicle display device including a first and a second display surfaces, which are discrete, the first display surface being semi-transparent and designed to create a virtual image obtained by reflection of an image produced by a display source, the second display surface being visible through the first display surface, said display device including a first display mode wherein at least one first information item is displayed on the first display surface and at least one second information item is displayed on the second display surface, characterized in that it further includes a second display mode wherein the at least one first information item and the at least one second information item are displayed on the second display surface and wherein the display source is switched off.

2. The vehicle display device according to claim 1, wherein the display source is a digital screen.

3. The vehicle display device according to claim 1, wherein the first display surface is a semi-transparent strip.

4. The vehicle display device according to claim 1, wherein the second display surface is a digital screen.

5. The vehicle display device according to claim 1, wherein the first information item corresponds to the speed of the vehicle.

6. The vehicle display device according to claim 1, wherein the second information item is selected from: a speed limitation, an indication relating to a cruise control.

7. A vehicle including a display device according to claim 1.
